(19) United States
(12) Patent Application Publication
(10) Pub. No.: US 2012/0022918 A1
(43) Pub. Date: Jan. 26, 2012

(54) METHOD OF CONDUCTING A LIVE, REAL-TIME INTERACTIVE REALITY SHOW FOR PEOPLE TO SEEK ADVICE

(76) Inventor: David Ross, Haverstraw, NY (US)

(21) Appl. No.: 13/187,383

(22) Filed: Jul. 20, 2011

Related U.S. Application Data
(60) Provisional application No. 61/366,122, filed on Jul. 20, 2010.

(51) Int. Cl. G06Q 30/00; G06F 15/16

(52) U.S. Cl. 705/7.32; 705/7.29; 705/14.73; 709/203

(57) ABSTRACT

A live, real-time interactive reality show is provided via multiple concurrent communication channels, including television broadcast, the internet, radio broadcast, cell phone airways, and landline phone lines. There are further included advice seekers and an audience that can utilize computers, televisions, cell phones, radios and landline phone lines to interact with or watch the reality show. Online web formats, including websites, blogs and other formats and cell phone applications, email, text messaging, and mobile applications may also be used to interact with or watch the reality show. The advice seekers interact in a live real-time unscripted manner. The audience may also be asked to offer advice and communicate it in real-time via a communication method, including the internet, email, text messaging, web cams, cell phones, land line phones, and mobile applications. The format of the real-time interactive reality show may be online via a web-based format, a television interview show format, a telephone call-in radio talk show format, a cellular phone interview format, or any combination of formats.

### BACKGROUND

1. Technical Field

Aspects of the present disclosure are directed generally to a method for conducting live real-time interaction through multiple communication channels and computer networks. More particularly, aspects of the present disclosure relate to a live, real-time interaction wherein a person seeks advice.

2. Description of the Related Art

People in present-day culture have a general fascination with public figures and celebrities, including those in entertainment, professional and amateur sports, business, media, or politics. Gossip and news programs are also of interest to the public communicated in such formats as print media, radio media, television media and on-line media. In recent years, reality shows have been produced for television in which people compete against each other in front of public figures, including celebrity judges. Although public figures and celebrity judges disseminate their thoughts to a competitor on such reality shows, a person in the audience has no way of interacting with the public figures or celebrity judges. Eventually, the person in the audience may lose interest in the show because there is no interaction possible.

Computer networks are used for many purposes including purchasing products online, locating special events, reading news stories, paying bills and playing games. Entertainment web sites may also be accessed on computer networks. Such entertainment web sites may focus on celebrity news and gossip, and are typically popular. In many of these entertainment web sites, a visitor may submit a comment or even a question to a posting wall or a type of message sending function. Submitting a comment or question, however, does not provide an experience of live seeking advice in a live real-time interaction environment with the host, celebrity or public figure, either in-person or in a virtual environment.

### BRIEF SUMMARY

The present disclosure provides for a live real-time interactive show that is entertaining and part of an enjoyable environment for an advice seeker to seek advice from a host, celebrity, public figure and audience.

Aspects of the present disclosure provide for a method and a system of conducting a live, real-time reality show in which an advice seeker may seek advice from hosts, celebrities, public figures, and an audience.

In one aspect of the present disclosure, the subject matter of questions is associated with the hosts, celebrity or public figure rather than unrelated sources or general trivia or directly related to the person seeking advice.

In another aspect of the present disclosure, an advice seeker asks advice of hosts, celebrity, public figure, or audience in questions related directly to the advice seeker.

In another aspect of the present disclosure, a host, celebrity or public figure can interview another host, celebrity, public figure, or audience and present a question.

In another aspect of the present disclosure, the person seeking advice asks a multiple-choice question in which the person seeking advice provides multiple answers for the hosts, celebrity, public figure, or audience to choose from.

In another aspect of the present disclosure, the host, celebrity, public figure, or audience may choose a topic from which people may seek advice. These can include love, teenage issues, prom dress, money, sex, holidays, employment, vacation, talent, education, weight loss, raising children, Santa Claus, the tooth fairy, and the like.

In another aspect of the present disclosure, the host, celebrity or public figure may choose a number of topics from which the greater audience may vote on for people to seek advice.

In another aspect of the present disclosure, the hosts, celebrity or public figure may provide more than one piece of advice and engage the greater audience to provide their own advice, and then engage the greater audience to help choose from an aggregate list of advice.

In another aspect of the present disclosure, the host, celebrity or public figure may solicit advice for the advice seeker from the audience, and then choose to have the greater audience vote on the solicited advice.

In another aspect of the present disclosure, the host, celebrity or public figure may solicit advice for the advice seeker from the greater audience and offer incentives for the audience to participate.

In another aspect of the present disclosure, the host, celebrity or public figure may choose which piece of advice from the greater audience to include by virtue of previous participation by audience members.

In another aspect of the present disclosure, the host, celebrity or public figure may choose which advice from the greater audience to include by virtue of a ranking of audience members based on previous participation and greater audience voting.

In another aspect of the present disclosure, the host, celebrity or public figure may solicit advice for the advice seeker from any of a psychiatrist, psychologist, and therapist.

In another aspect of the present disclosure, the host, celebrity or public figure may talk with any of a psychiatrist, psychologist, or therapist to evaluate given advice, and or offer it.

In another aspect of the present disclosure, the audience may earn points through participation, which may contribute to their ranking among the other audience members.

In another aspect of the present disclosure, the host, celebrity or public figure may choose which advice from the greater audience to include by virtue of a ranking of audience members based on a lottery.

In another aspect of the present disclosure, the host, celebrity or public figure may choose which advice from the greater audience to include to the advice seeker based on how quick an audience member responds with advice.

In another aspect of the present disclosure, the host, celebrity or public figure may choose which advice from the greater audience to include based on how many times in the past an audience member has offered advice.

In another aspect of the present disclosure, the host, celebrity or public figure may choose which advice from the greater audience to include by virtue of the answers from the audience with a key word that relates to the question.

In another aspect of the present disclosure, the host, celebrity or public figure may choose which advice from the greater audience to include by virtue of a pre-registration by a greater audience member, which could include a name, email address, address, age, profession, and interests.

In another aspect of the present disclosure, the host, celebrity or public figure may engage in rock, paper, scissors or flipping a coin or some other game of chance to decide which advice to provide to the advice seeker.

In another aspect of the present disclosure, the host, celebrity or public figure may utilize GPS to show where the question from the advice seeker or advice from the greater audience is coming from.

In another aspect of the present disclosure, the advice seeker or greater audience may rate or rank the advice of the hosts, celebrity or public figure.

In another aspect of the present disclosure, the advice seeker and greater audience may choose and use an avatar to seek or provide advice.

In another aspect of the present disclosure, the greater audience can see the asked questions as they are asked or posted, and they can note to the host, celebrity, public figure, and greater audience if the asked or posted question is similar to one already asked or posted. Those questions having been asked or posted by common audience members may raise to the top of the list of questions the host may answer.

In another aspect of the present disclosure, the live real-time interaction is provided in different environments, yet at concurrent times. For example, such environments may be a computing environment including an online environment, a web-based environment, a television environment; a radio environment; a wireless communications environment from a cellular phone (e.g., text or talk) or from landline phones, or a general computing environment that includes email, blogs, and websites.

In another aspect of the present disclosure, the person seeking advice, the host, celebrity or public figure can send data that provides a visual representation of the questions or advice.

In another aspect of the present disclosure, the person seeking advice can be exposed to information on products and services of a sponsor based on key words the person communicates in the question, based on the topic of the question, or based on the person's location. The information can be presented in a variety of formats through communication channels the person seeking advice is using, including in-stream, tap-to-video, in-banner, interstitial, within applications, on a website, blog, cell phone, email, text messaging, and television.

The above aspects, features and advantages of the present disclosure will be readily apparent and fully understood from the following detailed description of preferred embodiments, taken in connection with the drawings.

### BRIEF DESCRIPTION OF THE SEVERAL VIEWS OF THE DRAWINGS

The previous Brief Summary and the following Detailed Description are better understood when read in conjunction with the drawings.

FIG. 1 is a schematic diagram of a live, real-time interactive environment between a host, celebrity or public figure, advice seeker, and audience according to the present disclosure.

FIGS. 2-5 illustrate various representative multimedia display environments that may be used in a live, real-time interactive reality show as carried out with reference to FIG. 1.

### DETAILED DESCRIPTION

The following description is divided into sub-sections to assist the reader. The sub-sections include: Terms; Overview; Communication Flow; Representative Display Environment; Selecting a Celebrity; Preprocessing for a Game Episode; Real-Time Game Show Environment; and a Summarization of an Interactive Competition.

### Terms

As used herein, the terms host, celebrity, and public figure, are defined as a person or people who have come into the attention of the community by way of notoriety or general frame from previous activities. A host, celebrity, and public figure, can be associated with industries including professional and amateur sports, entertainment, music, motion picture, business, print and electronic media, politics, and the like.

As used herein, the term advice seeker is defined as a person seeking advice.

As used herein, the term greater audience is defined as a person or people comprised of advice seekers, or people who want to watch or know about the interaction between a host, celebrity or public figure, and advice seekers. The greater audience may also include people who can be asked to provide advice, and may provide advice. The greater audience can also become advice seekers.

As used herein, the term studio audience is defined as a group of people who are in the same location as the live, real-time interactive reality show. The studio audience may comprise advice seekers and people who want to watch or know about the interaction between a host, celebrity or public figure, and advice seekers.

As used herein, the phrase live is defined as not pre-recorded.

As used herein, the phrase real-time is defined as a broadcast of the live, real-time interactive reality show as it is occurring.

As used herein, the phrase interactive is defined as a two-way communication.

### Overview

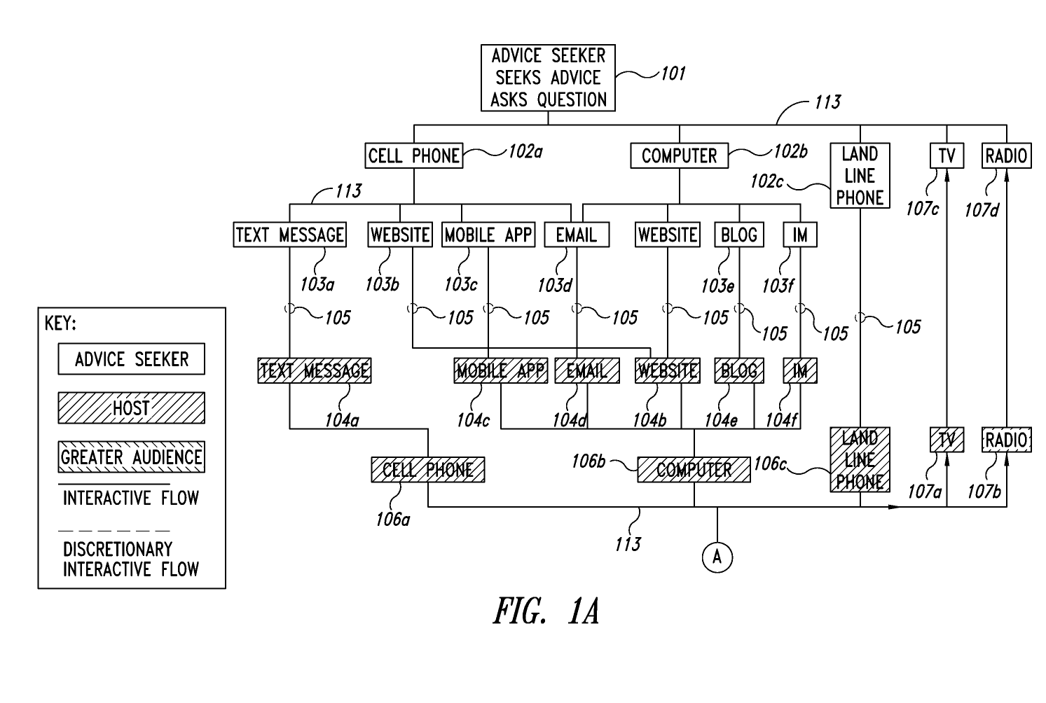

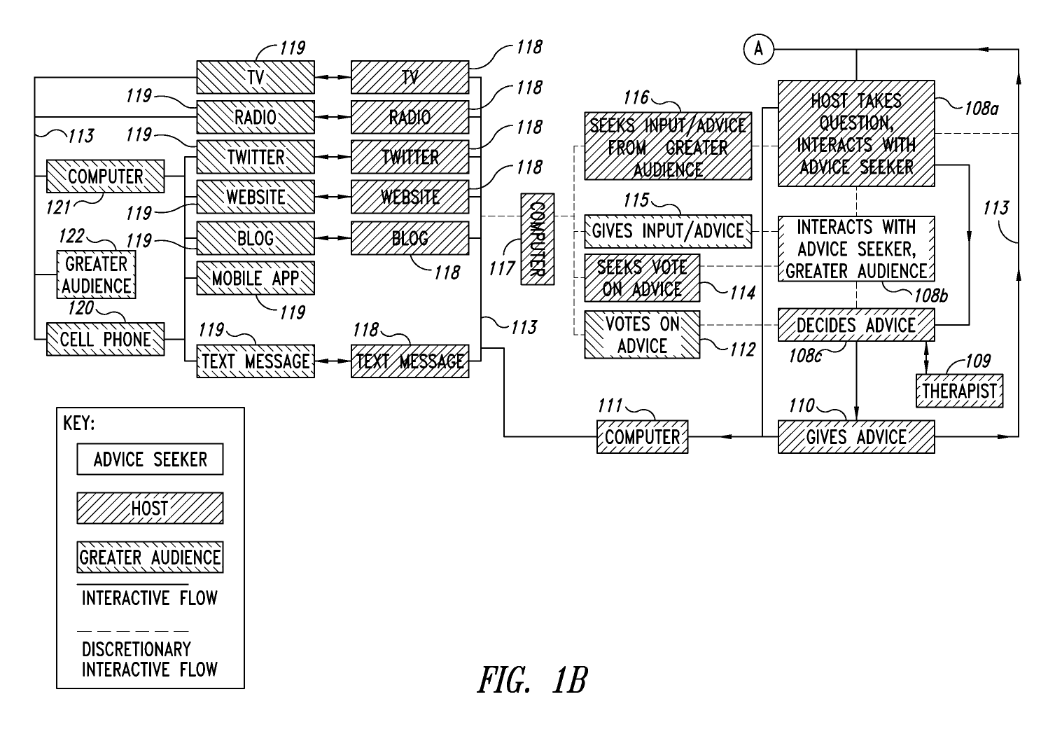

As an overview in FIG. 1, aspects of the presently disclosed subject matter provide an entertaining enjoyable environment in which a person interacts live, in real-time, with a host, celebrity or public figure.

### Live Real-Time Interactive Interactive Communication Flow

FIG. 1 schematically illustrates the channels and live real-time interactive communication flow between advice seekers, hosts, celebrity or public figure, and the greater audience.

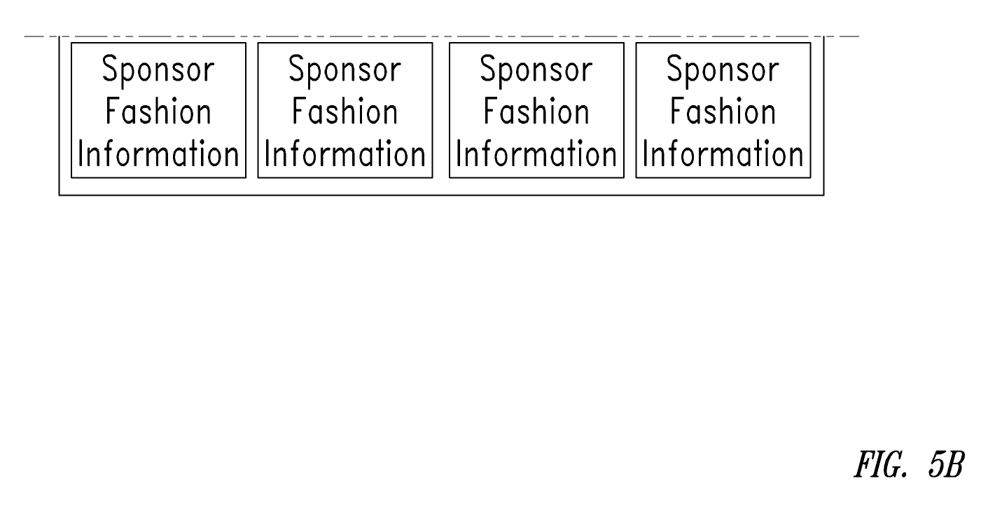

As seen in FIG. 1, the advice seeker 101 has a question and contacts the host, celebrity or public FIG. 108a in real-time with the question (or questions) through a cell phone 102a, computer 102b, or landline phone 102c via a channel or channels of their choice, which include conventional landline phone communication, text message 103a, website 103b, mobile app 103c, email 103d, blog 103e or IM (instant messaging) 103f, or any combination of the foregoing. The host, celebrity or public FIG. 108a receives the questions through similar communication channels 104a-104f and 106c as the advice seeker 101, and will interact with the advice seeker 101 live, in real-time, which may be broadcast on TV 107a, radio 107b and the internet over a computing device 106b. The host, celebrity or public FIG. 108a may consider the question or questions and may give advice to the advice seeker 101 in real time, or, may interact and seek additional advice from the greater audience 122 live, in real-time, or both. The host, celebrity or public FIG. 108a can ask the greater audience 122 to offer advice at 116 and this advice can be voted on by the greater audience 122 at 112 based on the discretion of the host, celebrity or public FIG. 108a in real-time. The advice seeker 101 or greater audience 122, or both, may also receive information on products and services of a sponsor in real-time, for example as seen in FIG. 5. The host, celebrity or public FIG. 108a can also solicit and validate advice with a psychiatrist, psychologist, or therapist 109 in real-time. Once the advice is decided upon by the host, celebrity or public FIG. 108a at 108c, the advice seeker 101 and greater audience 122 are informed live, in real-time via multiple channels 104a-104f, 106c, 107a, and 107b, which may include, a landline phone 106c, text message 104a, website 104b, mobile app 104c, email 104d, blog 104e or IM 104f or both, and television 107a and radio 107b.

### Representative Display Environments

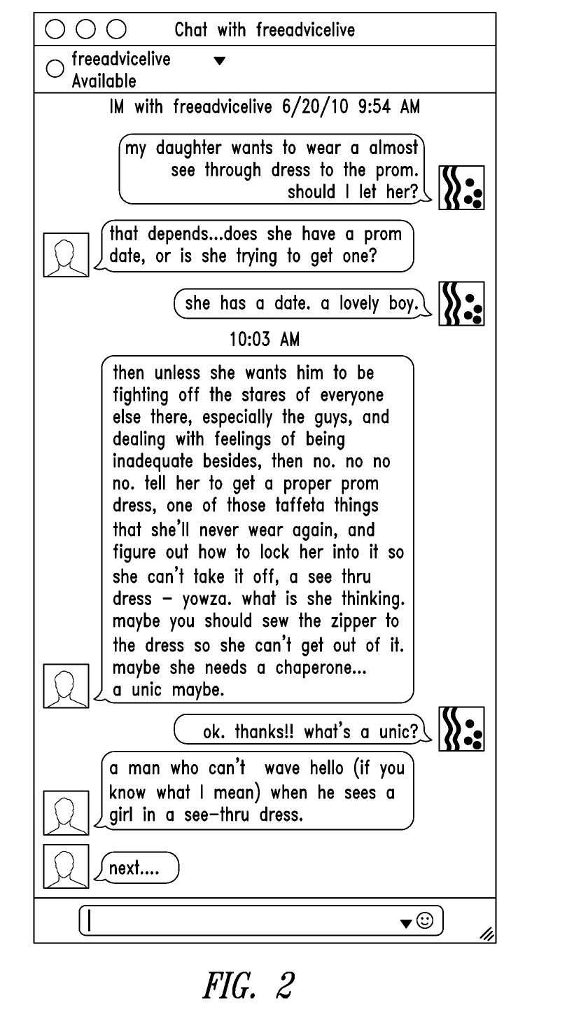

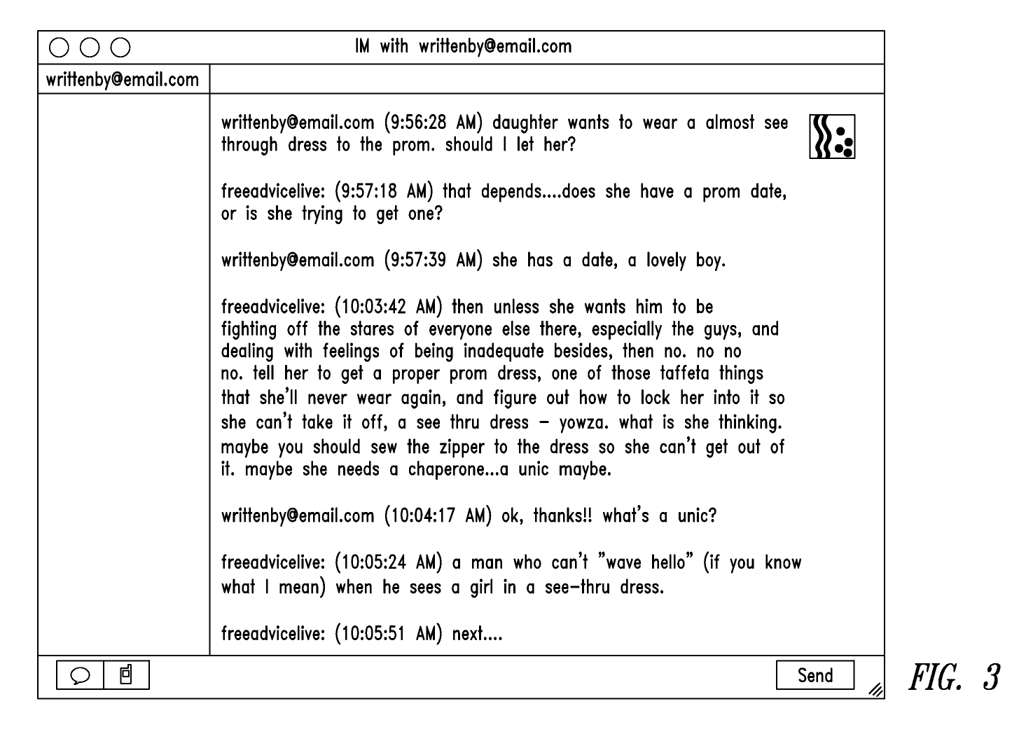

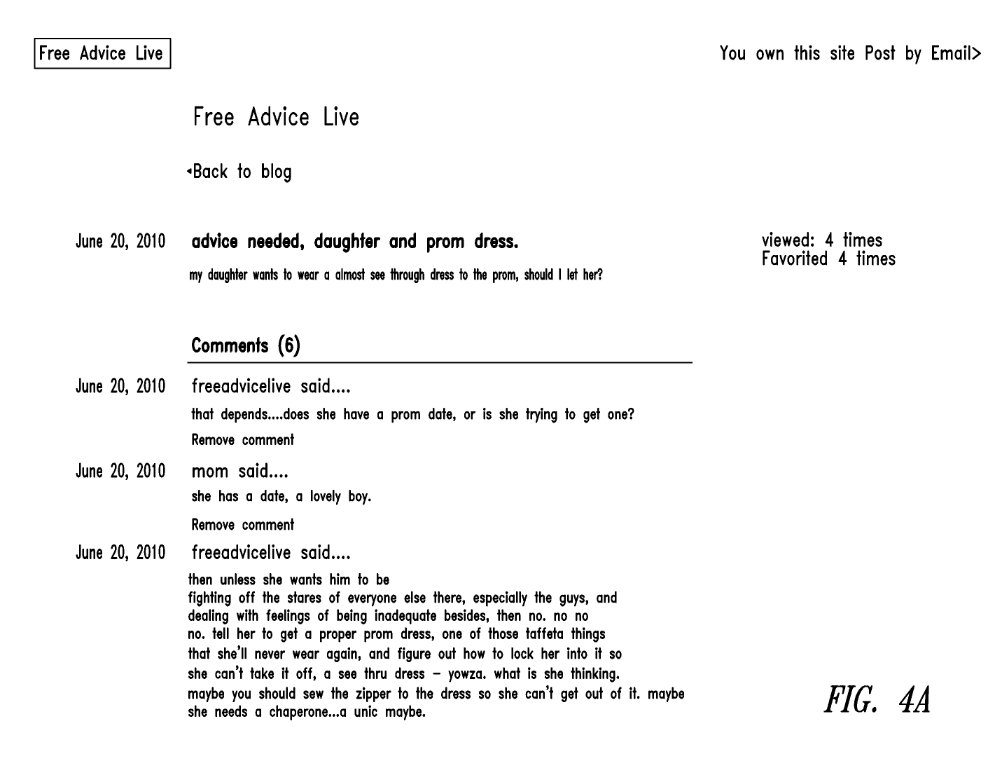

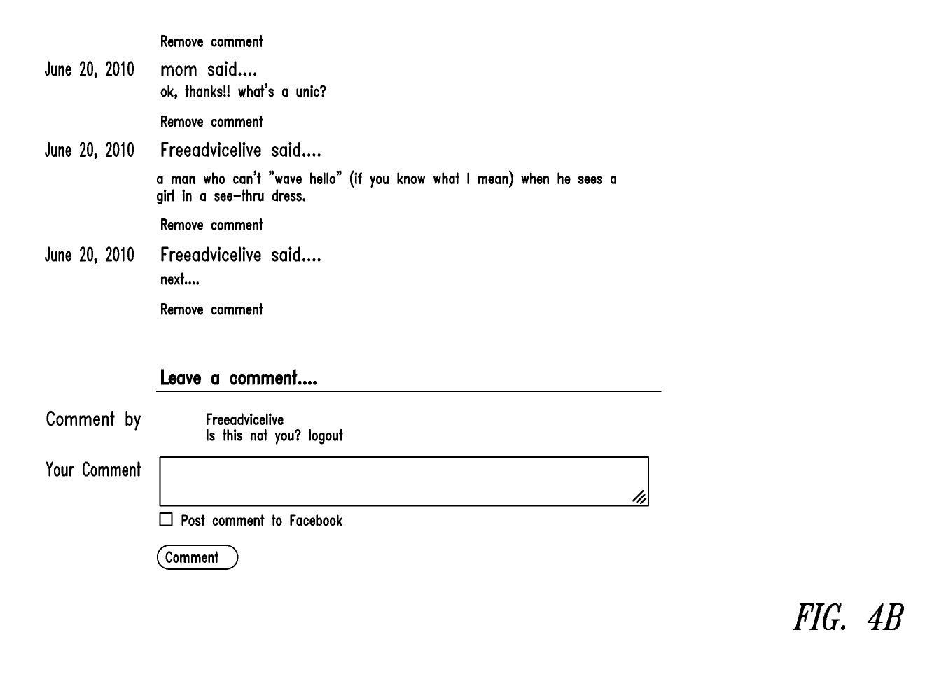

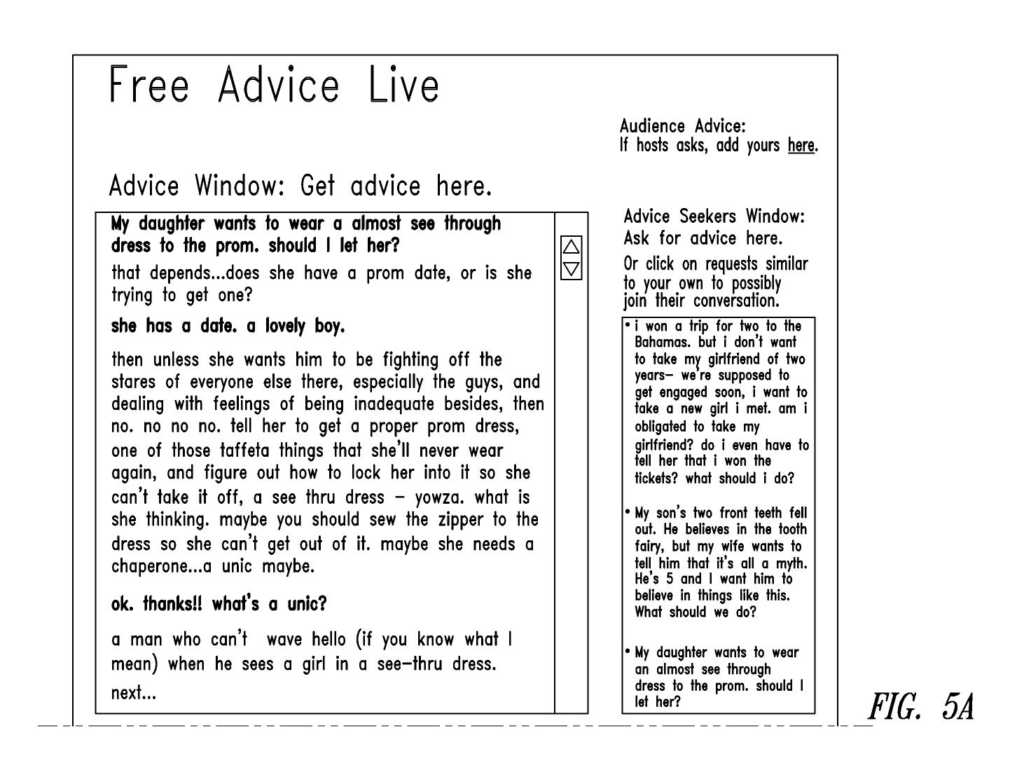

FIGS. 2-3 illustrate various examples of Instant Messaging (“IM”) or chat environments in which the advice seeker 101 may ask for advice from the host, celebrity or public FIG. 108a over websites 103b and 104b, and IM 103f and 104f. The host, celebrity or public FIG. 108a responds in real time with advice. Afterwards, the live, real-time interaction may end. Interaction is not limited to the IM and chat environments as shown in FIGS. 2-3. Any environment that allows network based communication between the advice seeker 101 and the host, celebrity or public FIG. 108a is contemplated within the scope of the present disclosure. For example, the advice seeker 101 may ask the one or more questions over a text message, but may receive a response from the host, celebrity or public FIG. 108a through an email 104d, mobile app 104c, landline phone 106c, TV 107a, or radio 107b. By way of another example of communication between the advice seeker 101 and the host, celebrity or public FIG. 108a, FIG. 4 illustrates a blog environment, preferably over the internet, in which the advice seeker 101 asks for advice from the host, celebrity or public FIG. 108a. The advice seeker 101 asks the question as a new entry on the blog. In response to the question from the advice seeker 101, various comments may be entered from other entities who have access to the internet and to the comment section of the blog shown in FIG. 4. The advice seeker 101 may check the blog post and comments periodically to get updated advice or even leave a comment with a follow-up question or to answer another commenter's question. The host, celebrity or public FIG. 108a may also respond in real time with advice over the comment section, for example. Once the advice has been given to the advice seeker 101, the live, real-time interaction may end, and the host, celebrity or public FIG. 108a may move on to another advice seeker, but the blog post may still remain open for additional comments to be posted.

In another embodiment of a communication environment where the advice seeker 101 and host, celebrity or public FIG. 108a may interact is show in FIG. 5, which illustrates a website environment, preferably over the internet, in which the advice seeker 101 asks for advice from the host, celebrity or public FIG. 108a. The host, celebrity or public FIG. 108a responds in real time with advice to the advice seeker 101 similar to the IM and chat environments shown in FIGS. 2-3. The website environment shown in FIG. 5 also enables the advice seeker 101 and greater audience 122 to see other requests, questions, or advice from other entities on the right-hand side of the screen, and to flag them as similar to their own. The website environment also enables the greater audience 122 to offer advice at the request of the host, celebrity or public FIG. 108a. Additionally, according to another embodiment, the website environment also enables information to be displayed for products and services of a sponsor of the live, real-time interactive show as seen at the bottom of the screen in FIG. 5. The information displayed may be chosen from at least one key word communicated in one or more questions, a topic of the one or more questions asked by the advice seeker 101 or member of the greater audience 122, or from the communication happening between the advice seeker 101 and the host, celebrity or public FIG. 108a.

### Selecting a Host, Celebrity, Public Figure

According to one embodiment, various approaches may be used to select a host, celebrity or public FIG. 108a for the live real-time interaction. An approach to selecting a celebrity may include a process of determining the popularity of a host, celebrity or public FIG. 108a. In general, a relatively high popularity can facilitate the selection of a celebrity for a show.

In one approach to determining a host, celebrity or public FIG. 108a based on popularity, web-based search requests can be used as a proxy for determining the popularity of a person. By way of example, search results on any search engine can indicate how many users are interested in a particular person. These search results may then be used to determine how popular a person is and then used when selecting the host, celebrity or public FIG. 108a. Other approaches may also be used as a proxy for determining the popularity of a person, which may include surveys or polling regarding name recognition of a person, the number of fan clubs or sites devoted to a person, the amount of general media coverage of a person, the magnitude of memorabilia available related to a person, the number of downloads of images of a person, or direct voting of who the public wants to receive advice from.

In an alternative embodiment to selecting a celebrity, the popularity of a type of media with which the celebrity is involved could be selected. Types of media may include sports leagues and teams, television shows, motion pictures, theatrical events, concerts, books, or songs. To determine the popularity of the type of media, the magnitude of web search results requesting information about the type of media could be examined to see which types of media receive the most information requests.

Alternatively, the relative magnitude of sales of the types of media could be used, as could name recognition of the types of media or media ratings of the type of media. The popularity of the types of media may be used as the basis for selecting the celebrity, rather than the direct popularity of the celebrity. This approach may be advantageous because some advice seekers may readily recognize the type of media associated with the celebrity rather than directly recognizing the celebrity alone. In one example, a popular TV show or movie may generate a lot of interest but have no highly popular person associated with that TV show or movie. An actor, director, or producer of the TV show or movie may be selected based on the popularity of the TV show or movie instead of their own popularity. In another example, a sports team that has won a major championship may be popular, but an individual player of the sports team might not be readily recognized. A professional football team that has won the Super bowl may have name recognition, but a specific player may not be highly popular. According to the present embodiment, a professional football player, or even coach, of the recognizable team may be selected and identified based on their association with the team for participation in the show.

### Preprocessing for a Show

Prior to a show, the voice or a video image, or both, of the celebrity may be recorded. In this process, a series of questions may be presented, and the celebrity will not provide an answer, but rather will talk about watching while he or she takes questions and provides answers live, in real-time. This aspect can be accomplished by a person asking the celebrity questions and during a telephone or an on-camera interview of the celebrity. If desired, other types of questions and formats can be used in this process.

### Live Real-Time Environment

As discussed above in the Live Real-time Interactive Communication Flow section of the present disclosure, a live real-time format may be a television show broadcast, for example. Accordingly, a host, celebrity or public FIG. 108a, and advice seekers 101 can communicate in real-time. In addition to television broadcast, the live real-time interactive communication may be provided via multiple concurrent communication channels, including the internet, radio broadcast, cell phone airways, landline phone lines, email, text messaging, mobile applications, and online web formats, including websites, blogs and other formats.

In one embodiment, the show may be transmitted live to a communications network, such as a satellite network, a broadband network, a cable TV network, or the internet including the World Wide Web.

In another embodiment, a host may perform the steps as shown in FIG. 1. For example, the host, celebrity or public FIG. 108a can interview another host, celebrity or public figure in a live talk show format and a question can be presented to one host from the other. Accordingly, a host, celebrity or public FIG. 108a can provide live real-time advice or other statements. The host, celebrity or public FIG. 108a can give the advice verbally or use other delivery methods, such as writing the answer down. The asking host may also provide commentary in response to the answer given by the host, celebrity or public FIG. 108a. Advice can also be exchanged between the host, celebrity or public FIG. 108a.

### A Summarization of the Live Real-Time Interactivity

A live real-time interactive reality show according to the present disclosure provides an entertaining enjoyable environment for a person to seek advice from hosts, celebrities or public figures. The live real-time interactivity can be provided via multiple concurrent communication channels, including television broadcast, the internet, radio broadcast, cell phone airways, landline phone lines, cable and DSL. The advice seekers and the greater audience can utilize computers, televisions, cell phones, radios and landline phone lines and utilize online web formats, including websites, blogs and other formats. These formats may include cell phone applications, landline phones lines, email, text messaging, and mobile applications to interact with or just watch the reality show in real time.

In one embodiment, the subject matter of asked questions can be associated with the hosts, celebrities or public figures rather than unrelated sources or general trivia, or directly related to the person seeking advice. In another embodiment, a person asks advice of hosts, celebrities or public figures 108a in one or more questions related directly to the person asking for advice as shown in FIG. 1. The advice seeker 101 may use a variety of bidirectional communication methods to both send and receive information, including a cell phone 102a, computer 102b, and conventional landline telephone 102c. The advice seeker may also receive information, such as advice, through unidirectional communication methods, such as TV 107c or broadcast radio 107d. Further still, if an advice seeker 101 uses the cell phone 102a or computer 102b, this may include different forms of communication, including text messaging 103a, website 103b (see FIG. 5 for an example of a website interface), mobile application browsing 103c, email 103d, blogging 103e (see FIG. 4 for an example of blog posting), and instant messaging 103f (see FIGS. 2 and 3 for examples of instant messaging). These forms of communication may be communicated to the hosts, celebrities or public figures 108a using any type of communication available, either singly or in combination with others. For example, the forms of communication may be communicated over the computing networks 105, such as by wire, wirelessly, or even satellite, or any combination of wire, wireless, or satellite.

Once the advice seeker 101 sends the one or more questions to the hosts, celebrities or public figures 108a through the various computing networks 105, the one or more questions are received by the hosts, celebrities or public figures 108a in FIG. 1. The hosts, celebrities or public figures 108a may receive communications through a cell phone 106a, computer 106b, or conventional landline telephone 106c. In one embodiment of the present disclosure, the form of communication sent by the advice seeker 101 is the same form of communication received by the hosts, celebrities or public figures 108a. The form of communication may also be of any form supported by either the advice seeker 101 or hosts, celebrities or public figures 108a. For example, the advice seeker 101 may send the one or more questions by a mobile application 103c across the computing networks 105, but the one or more questions are received by the hosts, celebrities or public figures 108a through an email 104d or standard website 104b on a computer 106b.

Once the hosts, celebrities or public figures 108a receive the one or more questions from the advice seeker 101, the one or more questions may be shared with a greater audience 122 through 108b, and others, including a therapist 109. The greater audience 122 may offer their own advice in addition to that of the hosts, celebrities or public figures 108a. The hosts, celebrities or public figures 108a may have a discussion regarding the one or more questions with one another, and include the general audience 122. The purpose being to ultimately provide a piece of advice to the advice seeker 101 based on a variety of inputs from different sources.

When a piece of advice is to be offered to the advice seeker 101, the hosts, celebrities or public figures 108a send it back through the communication methods that the advice seeker 101 could use to send the one or more questions. These include the cell phone 106a, the computer 106b, the conventional landline telephone 106c, the television transmission point 107a, and the radio transmission point 107b. As before, the television transmission point 107a and the radio transmission point 107b are unidirectional, only sending information from the hosts, celebrities or public figures 108a to the television 107c or the radio 107d; they cannot receive information from the television 107c or the radio 107d.

In another embodiment, the communication method for giving advice from the hosts, celebrities or public figures 108a through 110 may be the same communication method used by the advice seeker 101 to send the one or more questions, but may also be a different communication method from the one used by the advice seeker 101. For example, if the advice seeker 101 used a text message 103a to send the one or more questions, the hosts, celebrities or public figures 108a could respond with advice using a text message 104a, but could also respond with advice over email 104d, a blog post 104e, or even over the conventional landline telephone 106c.

In one embodiment, the hosts, celebrities or public figures 108a decide on advice at 108c, which may come from a variety of sources, including the discussion among the hosts, celebrities or public figures 108a, the general audience interaction 108b, and the therapist 109. To receive advice from the therapist 109, the hosts, celebrities or public figures 108a simply ask the therapist 109 and the therapist 109 responds. To receive advice from the general audience through 116, however, the hosts, celebrities or public figures 108a seek input from the general audience at 116 and receive the general audience advice at 115.

According to one embodiment, the hosts, celebrities or public figures 108a may seek advice from the general audience at 115 through a computer 117. Using the computer 117, various forms of communication 118 and 119 may be used to communicate with the greater audience 122. For example, the hosts, celebrities or public figures 108a may be part of a radio broadcast show, which is not only transmitted over the broadcast airwaves, but also simultaneously over their website with a corresponding blog. The general audience 122 may receive the broadcast by radio or by computer 121, and may interact via computer 121 or even cell phone 120.

According to the present embodiment, when the hosts, celebrities or public figures 108a are ready to offer a piece of advice to the advice seeker 101, they may ask the general audience 122 for advice, or to vote on several pieces of advice at 114. In one embodiment, the general audience 122 is presented with a list of advice choices to vote on as proposed from not only the hosts, celebrities or public figures 108a, but also from the therapist 109 and other audience members in the general audience 122, which may include a studio audience. When the hosts, celebrities or public figures 108a have presented the general audience with the advice choices, a vote is tabulated at 112.

According to various embodiments, the votes tabulated at 112 may be received from a variety of different sources, including twitter, a website, blog posts, emails, text message, and telephone voting (118 and 119). Once the votes from the general audience 122 have been tabulated, the hosts, celebrities or public figures 108a decide at 108c which piece of advice to give at 110 to the advice seeker 101. The decision at 108c may be a piece of advice voted on by a majority of general audience members 122, or it may be determined based on other criteria, such as a weighted vote, where votes from more reliable sources, such as a studio audience member are worth more than a vote from a general audience over the website. In this way, voting may be more reliable and less prone to multiple votes from the same entity. Other forms of vote tabulation are also contemplated within the present disclosure. For example, previous participation from audience members, how quickly an audience member responds to a request for advice, or even a lottery system may be used to pick a piece of advice to send to the advice seeker 101.

According to another embodiment, the general audience 122 may click on a link as seen in FIG. 5, which permits the general audience member to enter his advice. In another embodiment, the hosts, celebrities or public figures 108a may have the advice seeker 101 or greater audience 122, or both, engage directly with the psychiatrist, psychologist, and therapist 109 and have the psychiatrist, psychologist, and therapist 109 render the advice. In another embodiment the hosts, celebrities or public figures 108a may have more than two advice seekers with similar questions engage simultaneously in conversation to get advice.

According to another embodiment, the general audience 122 may not be allowed to participate in discussion or advice options. In this embodiment, only the hosts, celebrities or public figures 108a, and their chosen guests (such as the therapist 109) and optionally the advice seeker 101, may participate in the conversation or decision on advice. In this way, only professional advice may be offered or limited to only those entities engaged in the conversation.

The live real-time interactive nature of the reality show is unscripted interactivity between advice seekers and hosts. The hosts provide live real-time unscripted advice to the advice seeker and moderates the discussion between other hosts, celebrities or public figures, and the general audience. For example, the advice seeker 101 uses a computer and Website over the internet and the interactivity occurs between the advice seeker 101 and hosts, celebrities or public figures 108a. The advice seeker 101 and greater audience 122 will see the interactivity on computers pointed to that web address, or on TV 107c, radio 107d, blogs 103e, and mobile apps 103c, or any combination of the foregoing. Additionally, the live, real-time display of information on products and services of a sponsor may be displayed on the website as seen in FIG. 5 of the live, real-time interactive show.

In addition, some embodiments according to the present disclosure may provide an API that allows the greater audience, other computing systems, and programs to programmatically invoke at least some of the described functionality, such as APIs provided by libraries or class interfaces (e.g., to be invoked by programs written in computer language) or otherwise, which may include using network service protocols such as via Web services. The APIs may be stored on a computer readable medium, such as a memory or other data storage device, as a set of programmable, executable instructions. These instructions may be accessed from the computer readable medium by a processor, which may execute the programmable, executable instructions to perform the functionality described in the various embodiments. The APIs may be stored and executed on a single computing device or stored and executed across multiple computing devices over a computing network.

The following claims are exemplary and are intended to include elements and steps described in the present disclosure in any combination or sub combination. Accordingly, there are any number of alternative combinations, which incorporate one or more elements from the present disclosure, including from the description, claims, and drawings, in various combinations or sub combinations. It will be apparent to those skilled in the relevant technology, in light of the present disclosure, that alternate combinations of various embodiments of the present disclosure, either alone or in combination with one or more other elements or steps, may be utilized as modifications or alterations or as part of the claims. It is intended that the written description of the present disclosure covers all such modifications and alterations.

What is claimed is:

1. A method of conducting a live, real-time interactive show for people to seek advice, the method comprising:
presenting one or more questions during the live, real-time interactive show through one or more communication channels over one or more computer networks, the one or more questions being presented to a host, celebrity or public figure from an advice seeker;
receiving a plurality of pieces of advice in response to the presented one or more questions during the live, real-time interactive show through the one or more communication channels over the one or more computer networks;
determining a representative piece of advice from the plurality of pieces of advice; and
transmitting the representative piece of advice to the advice seeker.

2. The method according to claim 1, transmitting the representative piece of advice includes sending data that causes visual display of the representative piece of advice.

3. The method according to claim 1, transmitting the representative piece of advice includes transmission methods of broadcasting on the internet, television, and radio.

4. The method according to claim 1, further comprising: selecting the host, celebrity or public figure for the live, real-time interactive show based on polling for name recognition of the host, celebrity or public figure.

5. The method according to claim 1, further comprising: selecting the host, celebrity or public figure based on the popularity of at least one of a television show, motion picture, musical presentation, play, sports team and general news program associated with the host, celebrity or public figure.

6. The method according to claim 1, presenting the one or more questions to the host, celebrity or public figure includes providing data that will cause the one or more questions to audibly play the host, celebrity or public figure.

7. The method according to claim 1, presenting the one or more questions to the host, celebrity or public figure further includes visually providing the question to the host, celebrity or public figure.

8. The method according to claim 1, the advice seeker is in a remote location apart from the location of the live, real-time interactive show.

9. The method according to claim 1, further comprising: presenting to the advice seeker or a member of a studio audience of the live, real-time interactive show information on products and services of a sponsor of the live, real-time interactive show on a display device.

10. The method according to claim 9, presenting to the advice seeker or the member of the studio audience information on products and services of the sponsor of the live, real-time interactive show on the display device based on at least one of key words communicated in the one or more questions, a topic of the one or more questions, or a location of the advice seeker or the member of the studio audience.

11. The method according to claim 1, the one or more questions include at least four sequential questions indirectly associated with the host, celebrity or public figure.

12. The method according to claim 1, further comprising: providing data causing a congratulatory message to audibly play to a greater audience from the host, celebrity or public FIG. 1f the representative piece of advice is voted the as the top piece of advice from the plurality of pieces of advice by the host, celebrity or public figure, or the greater audience.

13. The method according to claim 1, further comprising: playing a consoling message to the advice seeker from the host, celebrity or public FIG. 1f the representative piece of advice given is not liked by the advice seeker.

14. A computer readable medium having computer-instructions causing a processor to execute a method for conducting a live, in real time interactive conversation between a host, celebrity or public figure, and an advice seeker, the method comprising:
presenting a question to the host, celebrity or public figure from the advice seeker during the live, in real time interactive conversation;
receiving advice options from an audience during the live, in real time interactive conversation, the audience includes at least one of a studio audience and a remote audience at a different location than the host, celebrity or public figure;
determining which of the advice options are viable should be presented to the advice seeker as an answer to the question presented; and
offering the viable advice options to the advice seeker during the live, in real time interactive conversation based on the advice options.

15. The computer readable medium according to claim 14, further comprising: adjusting an audience ranking if the viable advice options offered are voted acceptable options by a greater audience, and if a piece of advice given by the host, celebrity or public figure matches any of the viable advice options offered and voted as acceptable options by the greater audience.

16. The computer readable medium according to claim 14, further comprising: selecting the celebrity for the competition based on internet search requests for the celebrity.

17. The computer readable medium according to claim 14, further comprising: selecting the celebrity for the competition based on polling among a greater audience for name recognition of the celebrity.

18. The computer readable medium according to claim 14, further comprising: selecting the host, celebrity or public figure for the competition based on a popularity of at least one of a television show, motion picture, musical presentation, play, sports team and general news program associated with the host, celebrity or public figure.

19. The computer readable medium according to claim 14, further comprising: providing the host, celebrity or public figure with a score in a rating system that includes other scores of different hosts, celebrities or public figures.

20. The computer readable medium according to claim 14, presenting the question to the host, celebrity or public figure includes providing data that causes the question to audibly play to the host, celebrity or public figure.

21. The computer readable medium according to claim 14, presenting the question to the host, celebrity or public figure includes sending data that causes the question to be visually displayed to the host, celebrity or public figure on a display device.

22. The computer readable medium according to claim 14, further comprising: presenting advice given by the host, celebrity or public figure that is visually displayed on a display device.

23. The computer readable medium according to claim 14, further comprising: introducing the host, celebrity or public figure to the advice seeker.

24. The computer readable medium according to claim 14, further comprising: providing an electronic link to information on products and services of a sponsor for the live, in real time interactive conversation on a display device.

25. The computer readable medium according to claim 14, further comprising: receiving multiple questions indirectly associated with the host, celebrity or public figure.

26. The computer readable medium according to claim 14, further comprising presenting a link to a discussion about the question.

27. The computer readable medium according to claim 14, further comprising providing data causing a congratulatory message to audibly play to the audience from the host, celebrity or public FIG. 1f the advice options received from the audience matches advice associated with the host, celebrity or public figure.

28. The computer readable medium according to claim 14, further comprising: providing data that causes a consoling message to audibly play to the audience from the host, celebrity or public FIG. 1f the advice options received from the audience do not match advice given from the host, celebrity or public figure.

29. The computer readable medium according to claim 14, further comprising: providing visual data and audio data representing the viable advice options for transmission over at least one communications network.
